(19) United States
(12) Patent Application Publication
(10) Pub. No.: US 2020/0125136 A1
(43) Pub. Date: Apr. 23, 2020

(54) SMART POST-IT-LIKE SYSTEM WITH FUNCTIONAL PLUG

(71) Applicant: TAIWAN NAME PLATE CO., LTD., Taoyuan City (TW)

(72) Inventors: WEN-CHENG YIN, NEW TAIPEI CITY (TW); HO-CHUAN HSU, NEW TAIPEI CITY (TW); KAI-LI PENG, HSINCHU COUNTY (TW)

(21) Appl. No.: 16/529,607

(22) Filed: Aug. 1, 2019

(30) Foreign Application Priority Data
Oct. 18, 2018 (TW) 107136816

(51) Int. Cl. G06F 1/16; G09F 9/30; G09F 27/00; H04B 5/00

(52) U.S. Cl. CPC G06F 1/1605; G09F 9/301; G09G 2380/04; G06F 1/1637; H04B 5/0031; G09F 27/005

(57) ABSTRACT

A smart post-it-like system with functional plug is provided, including at least one main body and a smart electronic device, wherein the at least one main body includes a system-on-chip unit, at least one interface circuit, and at least one functional plug. The system-on-chip unit is disposed in the main body. One end of each of the interface circuits is disposed on the main body and connected to the system-on-chip unit, and one end of each of the functional plugs is connected to another end of each of the interface circuits. A smart electronic device is connected to each of the system-on-chip units, wherein the smart electronic device transmits a setting message to one of the system-on-chip units, and one of the system-on-chip units operates the setting message to generate a first operational message to be transmitted to each of the interface circuits.

### CROSS-REFERENCE TO RELATED APPLICATION

This application claims priority from Taiwan Patent Application No. 107136816, filed on Oct. 18, 2018, in the Taiwan Intellectual Property Office, the content of which is hereby incorporated by reference in its entirety for all purposes.

### BACKGROUND OF THE INVENTION

### 1. Field of the Invention

The present invention relates to a thin electronic device with sensing and reminding functions, more particularly to a smart post-it-like system with functional plug.

### 2. Description of the Related Art

The conventional electronic devices with sensing and reminding functions nowadays only either sense a fixed sensing target or have a specific way to remind users. The sensing target or the way of reminding users may thus not be flexibly adjusted according to the need for use or environment at the moment. In addition, when the users attempt to sense a plurality of targets by using this type of electronic devices, it is required to purchase an additional electronic sensing device with different sensing functions in an effort to satisfy the need for use.

Furthermore, both the sensing element and the reminding element of the conventional electronic devices with sensing and reminding functions nowadays are disposed in the same electronic device. Even if a message sensed by the electronic device at the moment matches with the setting condition and the reminding element is further activated to perform the reminding function, the user may not effectively receive the reminding message of the reminding function under the circumstance that the distance between the user and the electronic is too long. This may lead to the user not being able to immediately cope with the problems associated with the precaution of the electronic device.

Accordingly, the inventor of the present invention has designed a smart post-it-like system with functional plug in an effort to overcome deficiencies in terms of current techniques so as to enhance the implementation and application in industries.

### SUMMARY OF THE INVENTION

In view of the conventional problems as mentioned above, the present invention provides a smart post-it-like system with functional plug, including at least one main body and a smart electronic device, wherein the at least one main body includes a system-on-chip (SOC) unit, at least one interface circuit, and at least one functional plug. The system-on-chip unit is disposed in the main body. One end of each of the interface circuits is disposed on the main body and connected to the system-on-chip unit, and one end of each of the functional plugs is connected to another end of each of the interface circuits. The smart electronic device is connected to each of the system-on-chip units, wherein the smart electronic device transmits a setting message to one of the system-on-chip units, the connected system-on-chip unit receives the setting message to generate at least one operational message, and the operational messages are then transmitted to each of the functional plugs via the interface circuits such that each of the functional plugs are driven correspondingly according to the operational messages.

Preferably, the operational messages may include a first operational message and a second operational message, and the functional plugs include: a first functional plug driven by the first operational message, wherein the first functional plug senses a surrounding environment or a target object to generate a sensing message to be transmitted back to the system-on-chip unit, and the system-on-chip unit transmits the sensing message to the smart electronic device; and a second functional plug driven by the second operational message, wherein the second functional plug generates a human or machine sensible signal according to the second operational message.

Preferably, the first functional plug may be a temperature-sensor, a humidity-sensor, a gas-sensor, or a gravity-sensor; and the second functional plug may be a light-emitting diode or a speaker.

Preferably, the system-on-chip unit may further generate a conditional message according to the setting message, and when the sensing message matches with the conditional message, the system-on-chip unit generates the second operational message corresponding to the sensing message and transmits the second operational message to drive the second functional plug accordingly via a corresponding interface circuit connected thereto.

Preferably, the main bodies may include a first main body and a second main body, and the first functional plug is provided on the first main body and a second functional plug is provided on the second main body, wherein the system-on-chip unit of the first main body generates a conditional message according to the setting message, and when the sensing message matches with the conditional message, the system-on-chip unit of the first main body generates the second operational message corresponding to the sensing message and transmits the second operational message to the system-on-chip unit of the second main body, and the system-on-chip unit of the second main body then transmits the second operational message to drive the second functional plug via a corresponding interface circuit connected thereto.

Preferably, the main bodies may include a first main body and a second main body, and each of the system-on-chip units of the first main body and the second main body includes a message transmission range, wherein the message transmission range of the system-on-chip unit of the first main body overlaps the message transmission range of the system-on-chip unit of the second main body, such that the system-on-chip unit of the first main body is able to transmit the second operational message to the system-on-chip unit of the second main body.

Preferably, the functional plug may be a temperature-sensor, a humidity-sensor, a gas-sensor, a gravity-sensor, a light-emitting diode, or a speaker.

Preferably, the main body may further include a power supply connected to the system-on-chip unit.

Preferably, the main body may further include a near-field communication (NFC) circuit, the near-field communication circuit is disposed in the main body and connected to the system-on-chip unit, the smart electronic device senses the near-field communication circuit within a default distance so as to generate a matching message, the smart electronic device generates the setting message according to the matching message, and the smart electronic device transmits the setting message to the system-on-chip unit corresponding to the near-field communication circuit.

In sum, the smart post-it-like system with functional plug of the present invention has the advantages as follows:

(1) Compared to conventional electronic devices with sensing and reminding functions, the main body of the smart post-it-like system with functional plug of the present invention includes at least one interface circuit, and each of the interface circuits may be connected to the functional plug.

In addition, the functional plug may be the first functional plug with a sensing function or the second functional plug with a reminding function, wherein the first functional plug may be a temperature-sensing sensor, a humidity-sensing sensor, a gas-sensing sensor, or a gravity-sensing sensor; the second functional plug may be a light-emitting diode or a speaker. Hence, the user may install an functional plug with a corresponding function on the interface circuit according to the need for use, and may further set a sensing condition in the setting message by the smart electronic device. Under the condition that the interface circuit is simultaneously connected to the first functional plug and the second functional plug, when the sensing message of the first functional plug matches with the conditional message, the system-on-chip unit disposed in the main body may generate the second operational message to further drive the second functional plug accordingly via a corresponding interface circuit connected thereto. In this way, performing the sensing and reminding functions simultaneously may be achieved by means of the main body of the smart post-it-like system with functional plug.

(2) The smart post-it-like system with functional plug of the present invention may not only realize the disposition of the first functional plug and the second functional plug with different functions on the same main body, but also drive the second functional plug connected to the second main body through the first functional plug connected to the first main body. When the sensing message of the first functional plug with a sensing function connected to the first main body matches with the conditional message, the system-on-chip unit of the first main body generates the second operational message according to the sensing message which may then be transmitted to the system-on-chip unit of the second main body and drives the second functional plug with a reminding function connected to the second main body. Accordingly, the user may set the main body having the first functional plug on the region to be sensed by means of this disposition and set the main body having the second functional plug at an appropriate distance, thus effectively increasing the reminding range.

To make the aforementioned purposes, technical features, and gains after actual implementation more obvious and understandable, the description hereinafter shall be illustrated in more detail with reference to preferred embodiments together with related drawings.

### BRIEF DESCRIPTION OF THE DRAWINGS

FIG. 1 depicts a configuration diagram according to the smart post-it-like system with functional plug of the present invention.

FIG. 2 depicts a first configuration schematic diagram according to the smart post-it-like system with functional plug of the present invention.

FIG. 3 depicts a second configuration schematic diagram according to the smart post-it-like system with functional plug of the present invention.

FIG. 4 depicts a third configuration schematic diagram according to the smart post-it-like system with functional plug of the present invention.

FIG. 5 depicts a configuration diagram of a near-field communication circuit according to the smart post-it-like system with functional plug of the present invention.

### DESCRIPTION OF THE PREFERRED EMBODIMENTS

In the present invention, it should be noted that the orientation or positional relationship regarding the terms “in,” “out,” and the like is based on the orientation or positional relationship as shown in the drawings, which is only for ease of describing the present invention and simplifying the description. The description does not indicate or imply that the referred devices or elements must have a particular orientation, construction, and operation. Therefore, it should not be understood as a restriction on the present invention. In addition, the terms “first” and “second” are used for descriptive purposes only and are not to be construed as indicating or implying relative importance.

In the description of the present invention, it should be noted that the terms “connect,” “attach,” “dispose,” “transmit” “operate,” “generate,” “sense,” and “drive” should be considered to be general understanding unless there is a specific regulation or restriction. The specific meanings of the aforementioned terms in the present invention shall specifically be understood by a person of ordinary skill in the art.

The embodiments of the smart post-it-like system with functional plug of the present invention are illustrated with reference to the related drawings. For ease of understanding, the same elements in the following embodiments are explained in accordance with the same symbols.

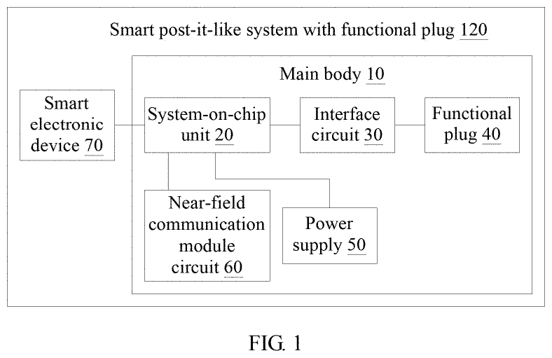

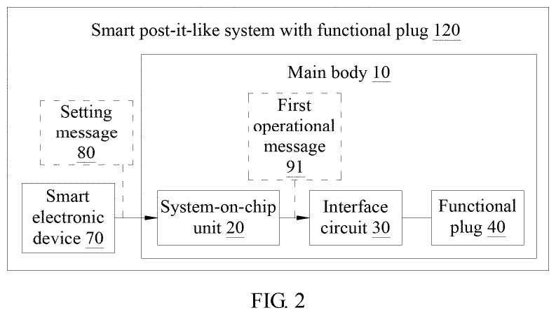

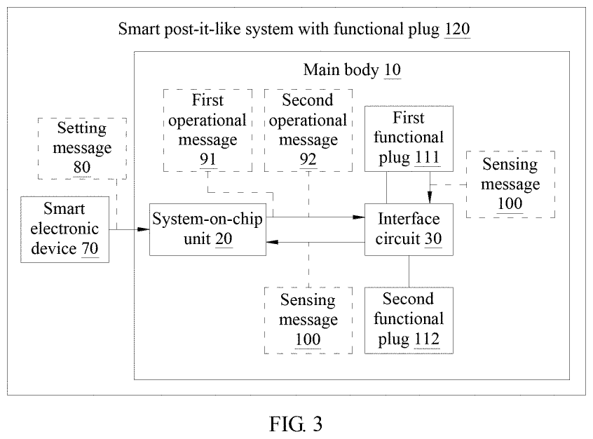

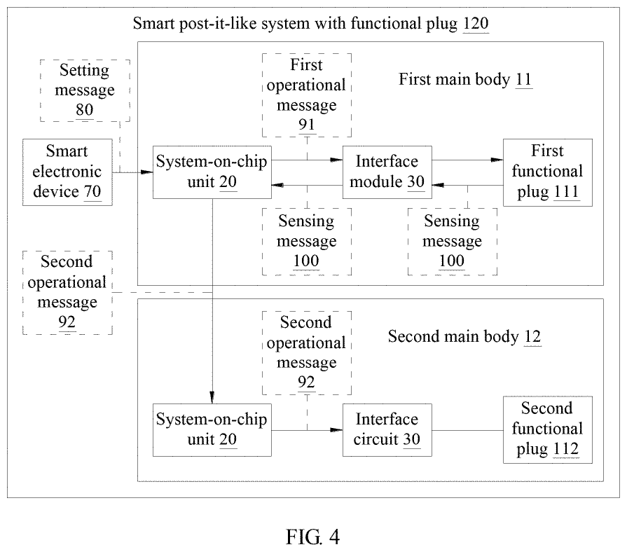

Please refer to FIG. 1, FIG. 2, FIG. 3, and FIG. 4, FIG. 1 depicts a configuration diagram according to the smart post-it-like system with functional plug of the present invention; FIG. 2 depicts a first configuration schematic diagram according to the smart post-it-like system with functional plug of the present invention; FIG. 3 depicts a second configuration schematic diagram according to the smart post-it-like system with functional plug of the present invention; FIG. 4 depicts a third configuration schematic diagram according to the smart post-it-like system with functional plug of the present invention.

As shown, the present invention aims to provide a smart post-it-like system with functional plug 120, including at least one main body 10 and a smart electronic device 70, wherein the at least one main body 10 includes a system-on-chip unit 20, at least one interface circuit 30, and at least one functional plug 40. The system-on-chip unit 20 is disposed in the main body 10; one end of each of the interface circuits 30 is disposed on the main body 10 and connected to the system-on-chip unit 20; one end of each of the functional plugs 40 is connected to another end of each of the interface circuits 30; the smart electronic device 70 is connected to each of the system-on-chip units 20. This is the first configuration of the present invention. Wherein, the smart electronic device 70 transmits a setting message 80 to one of the system-on-chip units 20, the connected system-on-chip unit 20 receives the setting message 80 to generate at least one operational message, the operational messages are then transmitted to each of the functional plugs 40 via the interface circuits 30 such that each of the functional plugs 40 are driven correspondingly according to the operational messages. Nonetheless, the aforementioned descriptions are only illustrated as examples and not limited thereto.

The functional plugs 40 include a first functional plug 111 and a second functional plug 112. The first afunctional plug 111 may be a temperature sensor, a humidity sensor, a gas sensor, or a gravity sensor; the second functional plug 112 may be a light-emitting diode or a speaker. Nonetheless, the aforementioned descriptions are only illustrated as examples and not limited thereto.

For instance, in the first configuration of the smart post-it-like system with functional plug 120 of the present invention, the user may transmit a setting message 80 to the system-on-chip unit 20 of the main body 10 through the smart electronic device 70. The connected system-on-chip unit 20 receives the setting message 80 to generate at least one operational message, the operational message are then transmitted to each of the functional plugs 40 via the interface circuits 30 such that each of the functional plugs 40 are driven correspondingly according to the operational messages. When the functional plug 40, as a temperature sensor, a humidity sensor, a gas sensor, or a gravity sensor with a sensing function, performs the sensing function, the sensing message may be displayed on the sensor. The user may learn the temperature and humidity, the included gases, or the speed or shift values of the target object installed with the main body 10 at the moment according to the display on the sensor. On the other hand, when the functional plug 40 is a light-emitting diode or the speaker with a sensing function, the functional plug 40 may perform the reminding function after receiving the first operational message 91, wherein the user may further either set the light-emitting frequency, light-emitting brightness, or any combination thereof of the light-emitting diode in the setting message 80, or set the sound volume, sound frequency, or the combination thereof. Nonetheless, the aforementioned descriptions are only illustrated as examples and not limited thereto.

The second configuration of the present invention is a derived configuration of the first configuration. In the second configuration, each of the functional plugs 40 may be a first functional plug 111 or a second functional plug 112, the interface circuit 30 drives the first functional plug 111 correspondingly according to the first operational message 91, the first functional plug 111 senses a surrounding environment or a target object to generate a sensing message 100 to be transmitted back to the system-on-chip unit 20, and the system-on-chip unit 20 transmits the sensing message 100 to the smart electronic device 70. The second functional plug 112 generates a human or machine sensible signal according to the second operational message 92. Nonetheless, the aforementioned descriptions are only illustrated as examples and not limited thereto.

The first functional plug 40 may be a temperature sensor, a humidity sensor, a gas sensor, or a gravity sensor; the second functional plug 112 may be a light-emitting diode or a speaker. Nonetheless, the aforementioned descriptions are only illustrated as examples and not limited thereto.

The system-on-chip unit 20 further generates a conditional message according to the setting message 80, and when the sensing message 100 matches with the conditional message, the system-on-chip unit 20 generates the second operational message 92 corresponding to the sensing message 100 and transmits the second operational message 92 to drive the second functional plug 112 accordingly via a corresponding interface circuit 30 connected thereto. Nonetheless, the aforementioned descriptions are only illustrated as examples and not limited thereto.

For instance, in the second configuration of the smart post-it-like system with functional plug 120 of the present invention, the user may transmit a setting message 80 to the system-on-chip unit 20 of the main body 10 through the smart electronic device 70. The connected system-on-chip unit 20 receives the setting message 80 to generate at least one operational message, and the operational messages are then transmitted to each of the functional plugs 40 via the interface circuits 30 such that each of the functional plugs 40 are driven correspondingly according to the operational messages. The operational messages include a first operational message 91 and a second operational message 92, and the functional plugs 40 include a first functional plug 111 driven by the first operational message 91 and a second functional plug 112 driven by the second operational message 92. The first functional plug 111 senses a surrounding environment or a target object to generate a sensing message 100 to be transmitted back to the system-on-chip unit 20, and the system-on-chip unit 20 transmits the sensing message 100 to the smart electronic device 70. The second functional plug 112 generates a human or machine sensible signal according to the second operational message 92. In addition, the system-on-chip unit 20 operates the setting message 80 to generate a conditional message; when the sensing message 100 matches with the conditional message, the system-on-chip unit 20 generates the second operational message 92 corresponding to the sensing message 100 which is transmitted to the interface circuit 30 correspondingly. The interface circuit 30 drives the second functional plug 112 correspondingly according to the second operational message 92. Therefore, the user may perform sensing and reminding functions simultaneously by using a single main body 10. Nonetheless, the aforementioned descriptions are only illustrated as examples and not limited thereto.

The third configuration of the present invention is a derived configuration of the second configuration. In the third configuration, the main bodies 10 include a first main body 11 and a second main body 12, and the first functional plug 111 is provided on the first main body 11 and a second functional plug 112 is provided on the second main body 12. The system-on-chip unit 20 of the first main body 11 generates a conditional message according to the setting message 80, and when the sensing message 100 matches with the conditional message, the system-on-chip unit 20 of the first main body 11 generates the second operational message 92 corresponding to the sensing message 100 and transmits the second operational message 92 to the system-on-chip unit 20 of the second main body 12. The system-on-chip unit 20 of the second main body 12 then transmits the second operational message 92 to drive the second functional plug 112 via a corresponding interface circuit 30 connected thereto. Nonetheless, the aforementioned descriptions are only illustrated as examples and not limited thereto.

The system-on-chip unit 20 of each of the main bodies 10 includes a message transmission range, the message transmission range of the system-on-chip unit 20 of the first main body 11 overlaps the message transmission range of the system-on-chip unit 20 of the second main body 12 such that the system-on-chip unit 20 of the first main body 11 is able to transmit the second operational message 92 to the system-on-chip unit 20 of the second main body 12. Nonetheless, the aforementioned descriptions are only illustrated as examples and not limited thereto.

For instance, in the third configuration of the smart post-it-like system with functional plug 120 of the present invention, the user may transmit a setting message 80 to the system-on-chip unit 20 of the main body 10 through the smart electronic device 70. The system-on-chip unit 20 operates the setting message 80 to generate a first operational message 91 to be transmitted to the interface circuit 30, and the interface circuit 30 drives the first functional plug 111 with a sensing function correspondingly according to the first operational message 91. The first functional plug 111 senses a surrounding environment or a target object to generate a sensing message 100 to be transmitted back to the system-on-chip unit 20, and the system-on-chip unit 20 transmits the sensing message 100 to the smart electronic device 70. The second functional plug 112 generates a human or machine sensible signal according to the second operational message 92. In addition, the system-on-chip unit 20 operates the setting message 80 to generate a conditional message; when the sensing message 100 matches with the conditional message, the system-on-chip unit 20 generates a second operational message 92 corresponding to the sensing message 100 which is transmitted to the system-on-chip unit 20 of the second main body 12. The system-on-chip unit 20 of the second main body 12 transmits the second operational message 92 to the interface circuit 30 correspondingly. The interface circuit 30 of the second main body 12 drives the second functional plug 112 correspondingly according to the second operational message 92. In addition, the system-on-chip unit 20 of each of the main bodies 10 includes a message transmission range. If the message transmission range of the system-on-chip unit 20 of the first main body 11 overlaps the message transmission range of the system-on-chip unit 20 of the second main body 12, the system-on-chip unit 20 of the first main body 11 is able to transmit the second operational message 92 to the system-on-chip unit of the second main body 12. Nonetheless, the aforementioned descriptions are only explained as examples and not restricted thereto.

The main body 10 further includes a power supply 50, and the power supply 50 is connected to the system-on-chip unit 20; wherein the power supply 50 may be a transformer unit connected to a power source or a charging unit having a charging function. Nonetheless, the aforementioned descriptions are only illustrated as examples and not limited thereto.

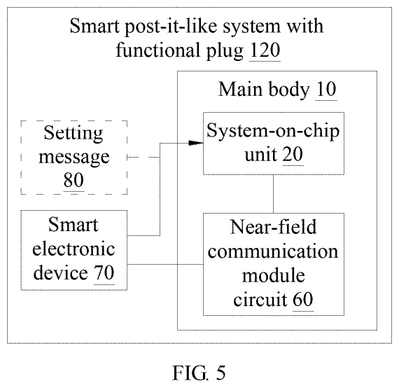

Please refer to FIG. 5 which depicts a configuration diagram of a near-field communication circuit according to the smart post-it-like system with functional plug 120 of the present invention. As shown, the main body 10 further includes a near-field communication circuit 60, the near-field communication circuit 60 is disposed in the main body 10 and connected to the system-on-chip unit 20, the smart electronic device 70 senses the near-field communication circuit 60 within a default distance so as to generate a matching message, the smart electronic device 70 generates the setting message 80 according to the matching message, and the smart electronic device 70 transmits the setting message 80 to the system-on-chip unit 20 corresponding to the near-field communication circuit 60. For instance, the user may sense the near-field communication circuit 60 of each of main bodies 10 that attempts to transmit the same setting message 80 simultaneously through the smart electronic device 70 within a default distance; the user may also set each aforementioned main body 10 as the same messaging group with the use of the smart electronic device 70. Therefore, the smart electronic device 70 may effectively transmit the same setting message 80 to the system-on-chip unit 20 of each of the main bodies 10 which is set as the same messaging group. Nonetheless, the aforementioned descriptions are only illustrated as examples and not limited thereto.

Compared to conventional electronic devices with sensing and reminding functions, the main body 10 of the smart post-it-like system with functional plug of the present invention includes at least one interface circuit 30, and each of the interface circuits 30 may be connected to the functional plug 40. In addition, the functional plug 40 may be the first functional plug 111 with a sensing function or the second functional plug 112 with a reminding function, wherein the first functional plug 111 may be a temperature sensor, a humidity sensor, a gas sensor, or a gravity sensor; the second functional plug 112 may be a light-emitting diode or a speaker. Hence, the user may install an functional plug 40 with a corresponding function on the interface circuit 30 according to the need for use, and may further set a sensing condition in the setting message 80 by the smart electronic device 70. Under the condition that the interface circuit 30 is simultaneously connected to the first functional plug 111 and the second functional plug 112, when the sensing message 100 of the first functional plug 111 matches with the conditional message, the system-on-chip unit 20 disposed in the main body 10 may generate a second operational message 92 and further drive the second functional plug 112 according to the sensing message 100. In this way, performing the sensing and reminding functions simultaneously may be achieved by means of the main body 10 of the smart post-it-like system with functional plug 120. Moreover. the smart post-it-like system with functional plug 120 of the present invention may not only realize the disposition of the first functional plug 111 and the second functional plug 112 with different functions on the same main body 10, but also drive the second functional plug 112 connected to the second main body 12 through the first functional plug 111 connected to the first main body 11. When the sensing message 100 of the first functional plug 111 with a sensing function connected to the first main body 11 matches with the conditional message, the system-on-chip unit 20 of the first main body 11 generates the second operational message 92 according to the sensing message 100 which may then be transmitted to the system-on-chip unit 20 of the second main body 12 and drives the second functional plug 112 with a reminding function connected to the second main body 12. Accordingly, the user may set the main body 10 having the first functional plug 111 on the region to be sensed by means of this disposition and set the main body 10 having the second functional plug 112 at an appropriate distance, thus effectively increasing the reminding range.

The above description is merely illustrative rather than restrictive. Any equivalent modification or alteration without departing from the spirit and scope of the present invention should be included in the appended claims.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Although the terms first, second, third, etc. may be used herein to describe various elements, components, loops, circuits, and/or modules, these elements, components, loops, circuits, and/or modules should not be limited by these terms. These terms may be only used to distinguish one element, component, loop, circuit or module from another element, component, loop, circuit or module. Terms such as “first,” “second,” and other numerical terms when used herein do not imply a sequence or order unless clearly indicated by the context. Thus, a first element, component, loop, circuit or module discussed below could be termed a second element, component, loop, circuit or module without departing from the teachings of the example implementations disclosed herein.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A smart post-it-like system with functional plug, comprising:
at least one main body, each of the main bodies comprising:
a system-on-chip (SOC) unit disposed in the main body;
at least one interface circuit, one end thereof disposed on the main body and connected to the system-on-chip unit; and
at least one functional plug, one end thereof connected to another end of each of the interface circuits; and
a smart electronic device connected to each of the system-on-chip units;
wherein the smart electronic device transmits a setting message to one of the system-on-chip units, the connected system-on-chip unit receives the setting message to generate at least one operational message, the operational messages are then transmitted to each of the functional plugs via the interface circuits such that each of the functional plugs are driven correspondingly according to the operational messages.

2. The smart post-it-like system according to claim 1, wherein the operational messages include a first operational message and a second operational message, and the functional plugs include:
a first functional plug driven by the first operational message, the first functional plug senses a surrounding environment or a target object to generate a sensing message to be transmitted back to the system-on-chip unit, and the system-on-chip unit transmits the sensing message to the smart electronic device; and
a second functional plug driven by the second operational message, the second functional plug generates a human or machine sensible signal according to the second operational message.

3. The smart post-it-like system according to claim 2, wherein the first functional plug is a temperature-sensor, a humidity-sensor, a gas-sensor, or a gravity-sensor; and the second functional plug is a light-emitting diode or a speaker.

4. The smart post-it-like system according to claim 2, wherein the system-on-chip unit further generates a conditional message according to the setting message, and when the sensing message matches with the conditional message, the system-on-chip unit generates the second operational message corresponding to the sensing message and transmits the second operational message to drive the second functional plug accordingly via a corresponding interface circuit connected thereto.

5. The smart post-it-like system according to claim 2, wherein the main bodies include a first main body and a second main body, and the first functional plug is provided on the first main body and a second functional plug is provided on the second main body, wherein the system-on-chip unit of the first main body generates a conditional message according to the setting message, and when the sensing message matches with the conditional message, the system-on-chip unit of the first main body generates the second operational message corresponding to the sensing message and transmits the second operational message to the system-on-chip unit of the second main body, the system-on-chip unit of the second main body then transmits the second operational message to drive the second functional plug via a corresponding interface circuit connected thereto.

6. The smart post-it-like system according to claim 5, wherein the main bodies include a first main body and a second main body, and each of the system-on-chip units of the first main body and the second main body comprises a message transmission range, the message transmission range of the system-on-chip unit of the first main body overlaps the message transmission range of the system-on-chip unit of the second main body, such that the system-on-chip unit of the first main body is able to transmit the second operational message to the system-on-chip unit of the second main body.

7. The smart post-it-like system according to claim 1, wherein the functional plug is a temperature-sensor, a humidity-sensor, a gas-sensor, a gravity-sensor, a light-emitting diode, or a speaker.

8. The smart post-it-like system according to claim 1, wherein the main body further comprises a power supply connected to the system-on-chip unit.

9. The smart post-it-like system according to claim 1, wherein the main body further comprises a near-field communication (NFC) circuit, the near-field communication circuit is disposed in the main body and connected to the system-on-chip unit, the smart electronic device senses the near-field communication circuit within a default distance so as to generate a matching message, the smart electronic device generates the setting message according to the matching message, and the smart electronic device transmits the setting message to the system-on-chip unit corresponding to the near-field communication circuit.
